(19) United States
(12) Patent Application Publication
(10) Pub. No.: US 2012/0296910 A1
(43) Pub. Date: Nov. 22, 2012

(54) METHOD AND SYSTEM FOR RETRIEVING INFORMATION

(76) Inventors: Michal Skubacz, Grobenzell (DE); Sonja Zillner, Munchen (DE)

(21) Appl. No.: 13/108,653

(22) Filed: May 16, 2011

(51) Int. Cl. G06F 17/30

(52) U.S. Cl. 707/740; 707/E17.046

(57) ABSTRACT

A method of retrieving information regarding an information resource, has the steps of: providing an information resource with a plurality of information instances from a first memory unit; providing a knowledge model with a plurality of type categories and a relationship between at least two type categories from a second memory unit; providing a multi-dimensional context model with a plurality of context categories and a number of dimensions corresponding to a number of the context categories from a third memory unit; annotating an information instance by one of the type categories; mapping at least one type category and/or annotating at least one information instance by one of the context categories; and; assigning a context variable to one of the context categories, the context variable determining a value of a context distance between the context category and the information instance mapped to the context category.

### TECHNICAL FIELD

The invention provides a method for retrieving information regarding a knowledge resource.

### BACKGROUND

The retrieval of information has greatly improved during the past decades. Still, one of the remaining challenges is a retrieval of information in vast collections of data, especially unstructured or semi-structured textual data.

A person on a task of finding information in collections of data is faced with large quantities of information and knowledge of which only a small portion is relevant for the task in focus. Depending on the current task, the user's prior knowledge and other circumstances, the user may be interested in finding different types of information all fulfilling the user search criteria expressed in some sort of a search query.

Pursuing a given search task, the focus of a person may shift over time not only to another topic but also to a different level of detail of expected information. Hereby persons tend to start searching for information on a very general level trying to understand a domain and structure of knowledge but with time and more queries the users get deeper in the domain and expect very specific information.

In other words, the information need of a user is not a stable variable. Instead the information need is continuously changing. The change is triggered by various aspects, e.g. the person's situation, his/her working focus, his/her current activities, changes in the user's environment, etc.

Commonly known methods are not able to address the continuous changes of the user's information needs. Hence, only methods for data and knowledge navigation and knowledge discovery are known.

### SUMMARY

According to various embodiments, a method can be provided allowing for retrieving information regarding a knowledge resource enabling an adjustment of information needs in terms of multiple facets.

According to an embodiment, a method of retrieving information regarding an information resource, may comprise:
providing at least one information resource from a first memory unit, the information resource including a plurality of information instances;
providing at least one knowledge model from a second memory unit, the knowledge model including a plurality of type categories and at least one relationship between at least one of said plurality of type categories and at least one other of said plurality of type categories;
providing a multi-dimensional context model from a third memory unit, the context model including a plurality of context categories, the context model having a number of dimensions corresponding to a number of said context categories;
annotating at least one information instance of said information resources by at least one of the plurality of type categories;
mapping at least one type category of said knowledge resource and/or annotating at least one information instance of said information resource by at least one of the plurality of context categories; and;
assigning a context variable to at least one of the plurality of context categories, said context variable determining a value of a context distance between said context category and said information instance mapped to said context category.

According to a further embodiment, the method may include the step of retrieving a subset of said plurality of information instances by adjusting at least one context variable. According to a further embodiment, the method may include the step of adjusting at least one of said context variables by at least one control element, the control element captioned by the context category assigned to said context variable. According to a further embodiment, the context model may include at least one relationship between at least one of said plurality of context categories and at least one other of said plurality of context categories. According to a further embodiment, said information resource can be an unstructured or semi-structured resource. According to a further embodiment, said information resource can be formed by at least one of a group of resources, the group of resources including a document, a text, a collection of images and a website. According to a further embodiment, said knowledge model can be a structured resource. According to a further embodiment, said knowledge model can be formed by at least one of a group of resources, the group of resources including a taxonomy, a thesaurus, an ontology, a dictionary, a set of keywords and a lexicon. According to a further embodiment, the adjusting of said at least one context variable may allow performing at least one of a group of actions on said subset of said plurality of information instances, the group of actions including a faceted browsing, a faceted search, a faceted navigation and a tree-like navigation. According to a further embodiment, the first memory unit and/or the second memory unit and/or the third memory may be formed by one memory unit.

According to another embodiment, a computer program product may contain a program code stored on a computer-readable medium and which, when executed on a computer, carries out a method described above.

According to yet another embodiment, a system for retrieval of information regarding an information resource, may comprise:
a memory unit storing an information resource, the knowledge resource including a plurality of information instances;
a memory unit storing a knowledge model, the knowledge model including a plurality of type categories and at least one relationship between at least one of said plurality of type categories and at least one other of said plurality of type categories;
a memory unit storing a multi-dimensional context model, the context model including a plurality of context categories, the context model including a plurality of context categories, the context model having a number of dimensions corresponding to a number of said context categories; and;
at least one calculation unit for
   annotating at least one information instance of said information resources by at least one of the plurality of type categories and for mapping at least one type category of said knowledge resource and/or annotating at least one information instance of said information resource by at least one of the plurality of context categories, said calculation unit further assigning a context variable to at least one of the plurality of context categories, at least one context variable determining a value of a context distance between said context category and said information instance mapped to said context category.

### BRIEF DESCRIPTION OF THE DRAWINGS

Advantages of the present invention will become more apparent and readily appreciated from the following description of the embodiments, taken in conjunction with the accompanying drawing:

FIG. 1 shows a schematic view of a possible embodiment of control elements.

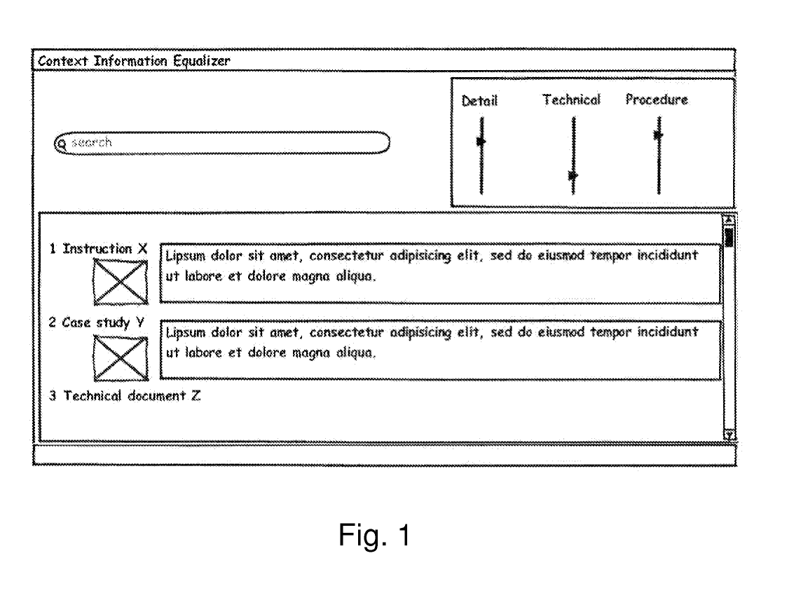

### DETAILED DESCRIPTION

According to various embodiments, a method for retrieving information regarding a knowledge resource may comprise the steps of:
providing at least one information resource from a first memory unit, the information resource including a plurality of information instances;
providing at least one knowledge model from a second memory unit, the knowledge model including a plurality of type categories and at least one relationship between at least one of said plurality of type categories and at least one other of said plurality of type categories;
providing a multi-dimensional context model from a third memory unit, the context model including a plurality of context categories, the context model having a number of dimensions corresponding to a number of said context categories;
annotating at least one information instance of said information resources by at least one of the plurality of type categories;
mapping at least one type category of said knowledge resource and/or annotating at least one information instance of said information resource by at least one of the plurality of context categories;
assigning a context variable to at least one of the plurality of context categories, said context variable determining a value of a context distance between said context category and said information instance mapped to said context category.

According to an embodiment, the context model directly links to information instances by annotating at least one information instance of said information resource by at least one of the plurality of context categories.

According to another embodiment, the context model indirectly links to information instances by mapping at least one type category of the knowledge resource by at least one of the plurality of context categories and by annotating at least one information instance of the information resource by at least one of the plurality of type categories. The two information sources can be integrated for characterizing the information instances by means of automated inference. The step of annotation is alternatively directed by a human operator or by an automated process.

According to yet another embodiment, both, the first and the second alternative as mentioned above, are applied.

Other embodiments further provide a system for a retrieval of information regarding an information resource.

In a possible embodiment of the method the method comprises retrieval a subset of said plurality of information instances by adjusting at least one context variable.

In a possible embodiment of the method the method comprises adjusting at least one of said context variables by at least one control element, the control element captioned by the context category assigned to said context variable.

The FIGURE shows a schematic view of a possible embodiment of control elements for adjusting the degree and/or the facets of information needs on retrieving information. The right window depicted in the FIGURE illustrates a user-interaction mechanism for assigning the context variables. Depending on the context of a user (technical expertise, required level of detail, preceding task within a procedure, . . . ), the user can specify the appropriate context variable by moving the depicted slide controller. The bottom window demonstrates a classical view of ranked information retrieval result. By adjusting the context variable, the user can access customized search request information.

Reference will now be made in detail to embodiments, examples of which are illustrated in the accompanying drawing.

The various embodiments address the general problem of information retrieval in vast collections of data, especially unstructured or semi-structured textual data. This kind of data collections includes collections of documents describing a particular product and its functionality (product documentation), collections of documents describing knowledge in a particular domain or domains, open collections of documents and texts like company intranet sites or Internet sites.

A user on a task of finding information in above mentioned collections of data is faced with large quantities of information and knowledge of which only a small portion is relevant for the task in focus. Depending on the current task, the user's prior knowledge and other circumstances the user may be interested in finding different types of information all fulfilling the user search criteria expressed in some sort of a search query. Pursuing a given search task, the focus of a user may shift over time not only to another topic but also to a different level of detail of expected information.

In general, the information need of a user is not a stable variable but is continuously changing. The change is triggered by various aspects, e.g. the user's situation, his/her working focus, his/her current activities, changes in the user's environment, etc. For addressing the continuous changes of the user's information needs, a straight forward user interaction mechanism to adjust the user's information needs is required.

The technical system described hereinafter is meant to improve the process of information retrieval by allowing the user to express user's expectations towards the search results in terms of expected abstract characteristics of information sought. This way, the user does not only specify the search query but additionally specifies the expected context.

In general, information retrieval systems supporting context sensitivity rely on existence of formal semantic models allowing estimation of contextual distance. This knowledge model can be formally represented in form of ontology whereas the ontology can be approximated based on documents or texts in focus using appropriate statistical algorithms.

Formal knowledge representing the application domain and the context of the user, for example formal knowledge about human anatomy, radiology or diseases in medical applications, is improving search applications. Without formal semantic models processing search queries is limited to indexing by keywords. Formal semantic models that formally capture the application domain and the users' search context pave the way for intelligent search applications by processing the meaning of search queries and by integrating and inferring additional knowledge from the formal semantic models. Semantic representation is generally realized by means of domain ontologies. And in a complex setting, the combination and alignment of several domain ontologies are used for the comprehensive multi-facetted representation of the domain.

By using semantically annotated data and ontologies, it becomes possible to personalize and customize the access to information accordingly the particular information needs of the user. Depending on the particular user context, the user's information need and requirement might differ significantly.

A search mechanism that is sensitive to context, however, can produce the correct result. There are many ways to realize context-sensitive search mechanisms. For instance, some approaches use the recent activity of a user as the context of their questions and searches. Other approaches rely on the context of applications in which the search is embedded or static information about the user's interest input by the user.

According to various embodiments, the seamless adjustment of an information need of the user that is represented within a context model can be enabled.

According to one aspect at least one information resource including a plurality of information instances is used. Such information resources may consist of any kind of resources including unstructured or semi-structured resources.

According to another aspect, a knowledge model including a plurality of type categories is used. This knowledge model is a structured resource, including a taxonomy, a thesaurus, an ontology, a dictionary, a set of keywords and a lexicon.

At least one information instance of the information resources is annotated by at least one of the plurality of type categories.

According to another aspect, a context model is provided. This context model is multi-dimensional in a sense that it contains a plurality of context categories whereby the number of dimensions is equal or corresponds to the number of context categories included in the context model. The context model includes context categories relevant for describing the various users' search spaces in terms of scope and level of detail, for example [symbol] Detail [symbol] , [symbol] Technical [symbol] , [symbol] Procedure [symbol] etc. At least one type category of the knowledge resource is mapped by at least one of the plurality of context categories.

According to a first embodiment, the context model directly links to information instances by annotating at least one information instance of said information resource by at least one of the plurality of context categories.

According to a second embodiment, the context model indirectly links to information instances by mapping at least one type category of the knowledge resource by at least one of the plurality of context categories and by annotating at least one information instance of the information resource by at least one of the plurality of type categories. The two information sources can be integrated for characterizing the information instances by means of automated inference. The step of annotation is alternatively directed by a human operator or by an automated process.

According to a third embodiment, both, the first and the second alternative as mentioned above, are applied.

For instance, according to the first alternative, information instance can be identified e.g. using lists of weighted keywords assigned to context categories. Those lists can be either manually specified or trained by the system exemplarily based on annotated examples. The context categories describing the search context are modeled in a way allowing identification of facets or logical dimensions of user's focus.

By assigning a context variable to at least one of the plurality of context categories, each context category or [symbol] facet [symbol] can be aligned with a linear information model ranging from a low degree to a high degree of a respective context category e.g. [symbol] Detail [symbol] .

According to various embodiments, the context variable is determining a value of a context distance between said context category and said information instance related to said context category.

According to an embodiment, a retrieving of a subset of the plurality of information instances is enabled by adjusting one or more context variables.

An adjustment of the context variables is preferably enabled by set of control elements according to the FIGURE, the control element captioned by the context category assigned to a respective context variable, e.g. [symbol] Detail [symbol] , [symbol] Technical [symbol] , [symbol] Procedure [symbol] etc.

This user-interactive mechanism allows a fine-tuning of information needs by a plurality of control elements or [symbol] sliders [symbol] which can be compared to an equalizer in the field of music recording and reproduction.

The search space or information space is adjusted along various context categories by moving the corresponding slide controller. Depending on the context of the user (expertise, role, search interest, tracked behavior, etc.), the user selects and retrieves the appropriate context representation, whereby appropriateness is defined in terms of size and coverage. Thus, the user of search applications can access customized search requested information much faster.

The application domain of the search application usually includes a plurality of relevant domain ontologies. The user context may vary, and with varying user context the relevance and appropriateness of underlying domain ontologies can increase or decrease.

The various embodiments provide a flexible mechanism for adjusting the scope and level of detail of the provided information units in retrieving information or researching for information whenever the user context and information need changes.

The determination of a particular knowledge model or a particular plurality of knowledge models may be based on an analysis of the user requirements, the knowledge models representing the range and variety of possible user contexts.

The established context model, which may be an ontology, reflects the different types such as role, task, and expertise, etc. as well as information needs of users.

Each category of the context model can be adjusted by means of a user interface of an [symbol] information equalizer [symbol] . A particular subset of the information instances is provided in accordance with a particular adjustment of the context variables.

According to an embodiment two stages are provided: A generation of a context ontology, hereinafter described as [symbol] offline phase [symbol] and an interactive usage, hereinafter described as [symbol] online phase [symbol] . Various research and/or information retrieval applications may be featured by this interactive usage.

As to the offline phase, relevant context categories are determined. The context categories are described in a dedicated context model or context ontology.

Each user has different information needs. According to his/her information needs, the appropriate search space for each user differs. The context ontology captures the concepts that allow describing any kind of search space instances.

For example, within a healthcare application the categories may comprise a category [symbol] technical [symbol] having a context ranging from generic to specific, a category [symbol] content detail [symbol] having a context ranging from generic to specific and [symbol] procedure [symbol] having a context range focusing on particular steps of a linear workflow or procedure.

The online phase is determined by a user interaction. The user interface, the so-called [symbol] information equalizer [symbol] allows the user to continuously specify or fine-tune or adjust the particular search space instance in accordance to his/her information needs.

The [symbol] look and feel [symbol] of the user interaction is inspired by an equalizer interface in the field of music recording and reproduction, comprising a number of sliders or any possible kinds of control elements like knobs, scroll bars, etc. The user is enabled to choose a facet of a search, in other words, a context category, by choosing a control element captioned by the context category and adjusting the [symbol] intensity [symbol] of the context category by adjusting the control element, thereby adjusting the context variable of the context category assigned to said context variable.

What is claimed is:

1. A method of retrieving information regarding an information resource, said method comprising:
providing at least one information resource from a first memory unit, the information resource including a plurality of information instances;
providing at least one knowledge model from a second memory unit, the knowledge model including a plurality of type categories and at least one relationship between at least one of said plurality of type categories and at least one other of said plurality of type categories;
providing a multi-dimensional context model from a third memory unit, the context model including a plurality of context categories, the context model having a number of dimensions corresponding to a number of said context categories;
annotating at least one information instance of said information resources by at least one of the plurality of type categories;
at least one of: mapping at least one type category of said knowledge resource and annotating at least one information instance of said information resource by at least one of the plurality of context categories; and
assigning a context variable to at least one of the plurality of context categories, said context variable determining a value of a context distance between said context category and said information instance mapped to said context category.

2. The method according to claim 1, comprising the step of
retrieving a subset of said plurality of information instances by adjusting at least one context variable.

3. The method according to claim 2, comprising the step of
adjusting at least one of said context variables by at least one control element, the control element captioned by the context category assigned to said context variable.

4. The method according to claim 1, wherein the context model comprises at least one relationship between at least one of said plurality of context categories and at least one other of said plurality of context categories.

5. The method according to claim 1, wherein said information resource is an unstructured or semi-structured resource.

6. The method according to claim 5, wherein said information resource is formed by at least one of a group of resources, the group of resources including a document, a text, a collection of images and a website.

7. The method according to claim 1, wherein said knowledge model is a structured resource.

8. The method according to claim 7, wherein said knowledge model is formed by at least one of a group of resources, the group of resources including a taxonomy, a thesaurus, an ontology, a dictionary, a set of keywords and a lexicon.

9. The method according to claim 1, wherein the adjusting of said at least one context variable allows performing at least one of a group of actions on said subset of said plurality of information instances, the group of actions including a faceted browsing, a faceted search, a faceted navigation and a tree-like navigation.

10. The method according to claim 1, wherein at least one of the first memory unit, the second memory unit, and the third memory are formed by one memory unit.

11. A computer program product comprising a computer readable medium, which stores a program code and which, when executed on a computer, carries out a method comprising:
providing at least one information resource from a first memory unit, the information resource including a plurality of information instances;
providing at least one knowledge model from a second memory unit, the knowledge model including a plurality of type categories and at least one relationship between at least one of said plurality of type categories and at least one other of said plurality of type categories;
providing a multi-dimensional context model from a third memory unit, the context model including a plurality of context categories, the context model having a number of dimensions corresponding to a number of said context categories;
annotating at least one information instance of said information resources by at least one of the plurality of type categories;
at least one of: mapping at least one type category of said knowledge resource and annotating at least one information instance of said information resource by at least one of the plurality of context categories; and
assigning a context variable to at least one of the plurality of context categories, said context variable determining a value of a context distance between said context category and said information instance mapped to said context category.

12. A system for retrieval of information regarding an information resource, the system comprising:
a memory unit storing an information resource, the knowledge resource including a plurality of information instances;
a memory unit storing a knowledge model, the knowledge model including a plurality of type categories and at least one relationship between at least one of said plurality of type categories and at least one other of said plurality of type categories;
a memory unit storing a multi-dimensional context model, the context model including a plurality of context categories, the context model including a plurality of context categories, the context model having a number of dimensions corresponding to a number of said context categories; and;
at least one calculation unit for annotating at least one information instance of said information resources by at least one of the plurality of type categories and for at least one of: mapping at least one type category of said knowledge resource and annotating at least one information instance of said information resource by at least one of the plurality of context categories, said calculation unit further assigning a context variable to at least one of the plurality of context categories, at least one context variable determining a value of a context distance between said context category and said information instance mapped to said context category.

13. The system according to claim 12, wherein the system is further operable to retrieve a subset of said plurality of information instances by adjusting at least one context variable.

14. The system according to claim 12, wherein the system is further operable to adjust at least one of said context variables by at least one control element, the control element captioned by the context category assigned to said context variable.

15. The system according to claim 12, wherein the context model comprises at least one relationship between at least one of said plurality of context categories and at least one other of said plurality of context categories.

16. The system according to claim 12, wherein said information resource is an unstructured or semi-structured resource.

17. The system according to claim 16, wherein said information resource is formed by at least one of a group of resources, the group of resources including a document, a text, a collection of images and a website.

18. The system according to claim 12, wherein said knowledge model is a structured resource.

19. The system according to claim 18, wherein said knowledge model is formed by at least one of a group of resources, the group of resources including a taxonomy, a thesaurus, an ontology, a dictionary, a set of keywords and a lexicon.

20. The system according to claim 12, wherein the adjusting of said at least one context variable allows performing at least one of a group of actions on said subset of said plurality of information instances, the group of actions including a faceted browsing, a faceted search, a faceted navigation and a tree-like navigation.
